(19) United States
(12) Patent Application Publication
(10) Pub. No.: US 2026/0106941 A1
(43) Pub. Date: Apr. 16, 2026

(54) POLICY PROVISIONING BASED ON VENDOR

(71) Applicant: T-Mobile USA, Inc., Bellevue, WA (US)

(72) Inventors: Suryaprakash Reddy Voodem, Bothell, WA (US); Rushabhkumar Patel, Newcastle, WA (US); Kameswaran Arunachalam, Snohomish, WA (US)

(21) Appl. No.: 18/912,059

(22) Filed: Oct. 10, 2024

(51) Int. Cl. H04M 15/00; H04W 4/12

(52) U.S. Cl. CPC H04M 15/66; H04M 15/8016; H04W 4/12

(57) ABSTRACT

Described herein are a policy node of a core network and another node of the core network. The other node sends a policy message that includes a vendor indicator to the policy node. The policy node determines a policy for the other node based at least in part on the vendor indicator and sends the policy to the other node in a policy response message. The policy may be one of a plurality of policies respectively associated by the policy node with a plurality of vendor indicators and the plurality of vendor indicators may include the vendor indicator.

### BACKGROUND

Increasingly, telecommunication networks are used to deliver a wide range of services. Home Internet services, business Internet services, and commercial Internet services are all delivered over this same infrastructure. These different services have different needs and priorities, however. To meet these demands, operators of telecommunication networks often implement different policies for the different services, providing the services with different speeds, qualities of service (QoS), etc. The operators also align infrastructure, such as core network nodes, with different services. For example, one vendor may be used for a certain node type when supporting one of the different services, and a different vendor may be used for that node type when supporting a different one of the services.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 shows a telecommunications network including multiple session management functions (SMFs) and a policy control function (PCF), the PCF determining policies for the SMFs based on vendor indicators received from the SMFs.

FIG. 2 is a call flow diagram illustrating messages exchanged between an SMF and a PCF, those messages conveying a vendor indicator and a policy determined based on that vendor indicator.

FIG. 3 is a flow diagram of an illustrative process for receiving, by a PCF, a message from another node that includes a vendor indicator, determining a policy for the other node based at least in part on the vendor indicator, and sending the policy to the other node.

FIG. 4 is a flow diagram of an illustrative process for sending, by an SMF, a message to a policy node, the message including a vendor indicator of a vendor of the SMF and receiving a policy from the policy node in response, the policy determined by the policy node based at least in part on the vendor indicator.

FIG. 5 is a schematic diagram of a computing device capable of implementing functionality of an SMF, the PCF, or multiple ones of these.

### DETAILED DESCRIPTION

This disclosure is directed in part to a policy node of a core network and another node of the core network exchanging a vendor indicator of the other node and a policy determined based on the vendor identifier. The other node sends a policy message that includes the vendor indicator to the policy node. The policy node determines a policy for the other node based at least in part on the vendor indicator and sends the policy to the other node in a policy response message. The policy may be one of a plurality of policies respectively associated by the policy node with a plurality of vendor indicators and the plurality of vendor indicators may include the vendor indicator.

In some implementations, the policy node may be a policy control function (PCF) and the other node may be a session management function (SMF). The PCF and SMF may communicate over an N7 interface, exchanging messages such as policy create messages, policy update messages, and their corresponding responses. The vendor indicators may be expressed in the headers of such messages, and the policies may be communicated back in the responses.

The inclusion of vendor indicators in messages sent from SMFs to a PCF allows the PCF to apply different policies to different SMFs when those different SMFs are associated with different vendor indicators. The different policies for different SMFs in turn allow those SMFs to support different services, such as home Internet, business Internet, and commercial Internet.

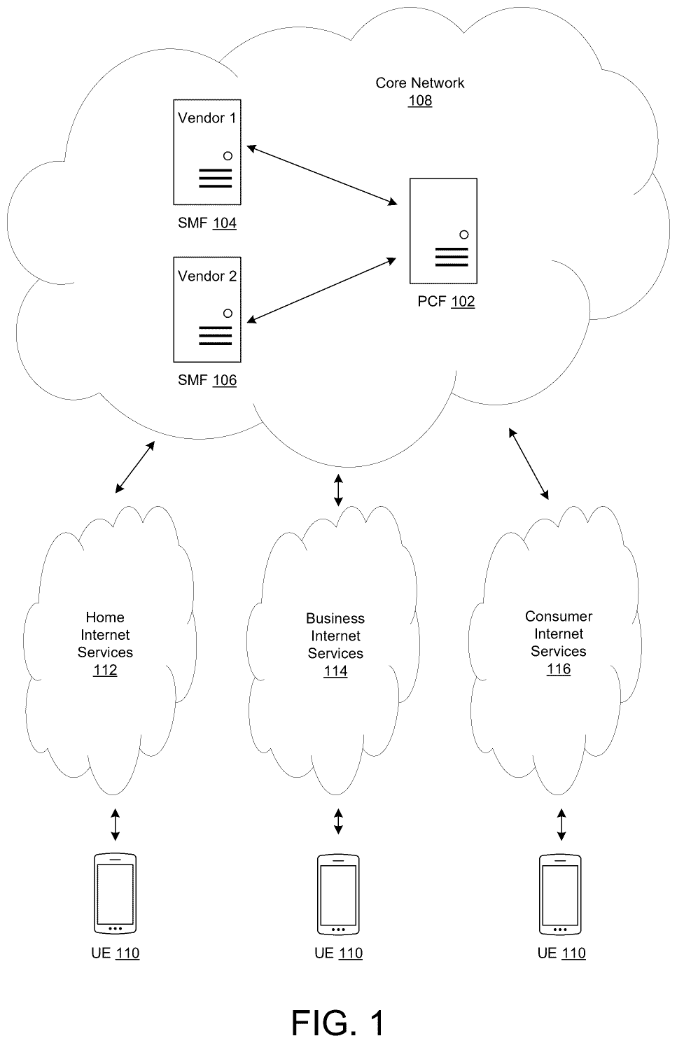

FIG. 1 shows a telecommunications network including multiple SMFs and a PCF, the PCF determining policies for the SMFs based on vendor indicators received from the SMFs. As illustrated, a PCF 102 may be connected to at least two SMFs, such as SMF 104 and SMF 106, and the PCF 102, SMF 104, and SMF 106 may all belong to a same core network 108. The different SMFs (e.g., SMF 104 and SMF 106) may support different services for user equipment 110 (UE 110), such as home Internet services 112, business Internet services 114, and commercial Internet services 116.

In various implementations, the core network 108 may be a Fifth Generation (5G) core network comprising PCF 102, SMFs 104 and 106, as well as other nodes such as user plane function(s), access and mobility management function(s), authentication server function(s), network function repository function(s), user data repositor(ies), unified data management node(s), charging function(s), etc. Earlier or later generation networks may also serve as core network 108, and the nodes of those earlier or later generation networks may serve similar purposes but go by different names.

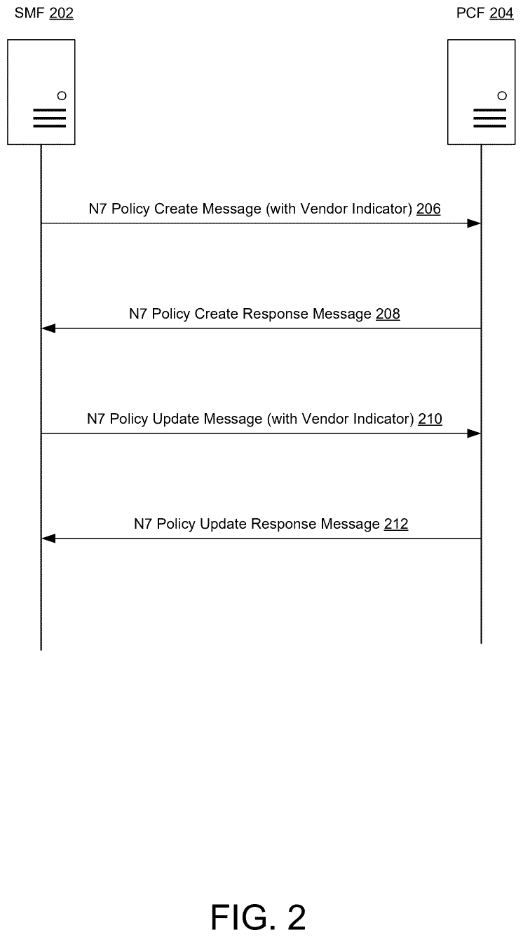

The PCF 102 may participate in managing policies applied at other nodes of a telecommunication network, including core network 108, to a data flow associated with a connection of a UE 110. For example, based on the subscriber identity, service type being used, etc., different policies featuring, e.g., different qualities of service (QoS), may be applied. PCF 102 has also been configured with logic to recognize vendor indicators in the policy messages it receives, consult a mapping of vendor indicators to policies, and based on that review, select a policy to apply to the sender of the policy message. Such a PCF 102 is illustrated in FIGS. 2, 3, and 5, and described in greater detail herein.

SMF 104 and SMF 106 are SMF instances that have primary responsibility, for the data sessions they support, for creating, updating, and removing protocol data unit sessions. Such sessions may be associated with services engaged by UEs 110, and in the context of creating or updating sessions, the SMFs 104 and 106 may send policy messages to the PCF 102. The SMFs 104 and 106 described herein may also include vendor indicators in those messages, identifying their respective vendors. For example, each of SMF 104 and SMF 106 may be associated with a different vendor. A vendor, in the context used herein, may be a manufacturer of all or of a component of SMF 104 or SMF 106, or an entity or person that configures the SMF 104 or SMF 106. Based on the vendor indicators and the policy messages which include them, the SMFs 104 and 106 receive policies in return from the PCF 102 and apply those policies to the protocol data unit sessions they support. Such SMFs 104 and 106 are further illustrated in FIGS. 2, 4, and 5 and described in greater detail herein.

As noted elsewhere herein, the interfaces of the connections between SMF 104 and PCF 102 and SMF 106 and PCF 102 may be N7 interfaces.

In various implementations, UE 110 may be any sort of mobile telecommunications device. For example, UE 110 may be a cellular phone, a tablet computer, a watch, goggles, an Internet-of-Things (IoT) device, a vehicle, a personal computer (PC), a gaming device, or any sort of device capable of wireless and/or cellular communication with telecommunications network. Further, UE 110 may be a device of a user who subscribes for telecommunication services with a network operator of the telecommunications network that includes core network 108.

Home Internet services 112, business Internet services 114, and commercial Internet services 116 are each shown in FIG. 1 as a separate network. In implementation, however, these services 112-116 may make use of same or different devices (e.g., radio access network devices, home/business routers, etc.) and same or different networks or subnetworks. They may each involve some different service/application, however, and if network slicing is used, may each have its own network slice(s). Due to such logical service/slice level separation, different core network nodes, such as SMF 104 and SMF 106, may be used to support different ones of services 112-116. An SMF 104/106 can support multiple ones of services 112-116, or a single one of such services.

FIG. 2 is a call flow diagram illustrating messages exchanged between an SMF and a PCF, those messages conveying a vendor indicator and a policy determined based on that vendor indicator. As illustrated in FIG. 2, SMF 202 may be an example of either SMF 104 or SMF 106. PCF 204 may be an example of PCF 102.

In various implementations, SMF 202 may request policies from the PCF 204 in a policy message 206 over an N7 interface. Such a policy message 206 may be an N7 policy create message (also simply referred to herein as a policy create message). The message 206 may include a vendor indicator in the header. Such a vendor indicator may be expressed in a field of the header, in a part of a field, it all or parts of multiple header fields, etc. The vendor indicator may also be indirectly expressed by the way in which other header fields of the policy message 206 or formatting of the policy message 206 is accomplished by the SMF 202. Such other fields or formatting may vary from vendor to vendor and thus indirectly express, even without a separate vendor indicator, an identity of a vendor of the SMF 202. But even with such indirect support, the SMF 202 may still include a vendor indicator that directly expresses the identity of the vendor. Such a vendor indicator, directly expressed, may be a string with a vendor name, or a numeric identifier used to distinguish the vendor from other vendors. Other data types are also possible for the vendor indicator.

The PCF 204, upon receiving the policy create message 206, retrieves the vendor indicator and checks a mapping stored on or available to the PCF 204 of vendor indicators and associated policies. Such a mapping could be a file, a data structure, a database, etc. and could be configured onto the PCF 204 by an operator of the core network 108 and updated by that operator. In some implementations, machine learning can be integrated into the mappings and used to updated them.

In further implementations, the PCF 204 can have another mapping (or addition to the mapping previously described) that maps specific SMFs, such as SMF 202, to policies. These mappings may be extended in response to retrieving associations of vendor indicators and policies—because the vendor indicators are taken from messages 206 that may also include SMF identifiers, those SMF identifiers may be associated with the policies retrieved based on vendor indicators and may then be stored in association with the policies. Subsequent messages 206 that may lack vendor indicators could use these additional mappings to identify policies.

If no vendor indicator is included in a message 206, and if there is no other association of information from the message 206 to a policy, the PCF 204 may determine a default policy to apply for the SMF 202.

Policies, in some implementations, may specify, for a user equipment/protocol data unit session, at least one of an uplink speed, a downlink speed, a QoS, a QoS class indicator (QCI), a charging rule base, or a charging rule name.

The identified policy (or an identifier of such a policy) may then be sent back to the SMF 202 in an N7 policy create response message 208 (hereinafter policy response message 208 or response message 208). The policy may either be data or a file included in the response message 208 or may be an identifier of such a policy when that policy is already stored on the SMF 202 or otherwise available to it.

The SMF 202 may then apply the policy to the protocol data unit session associated with the message 206. By applying the policies, the SMF 202 may provide the appropriate support for services associated with the protocol data unit session (such as one of services 112-116) and the UE (such as UE 110) utilizing such services.

FIG. 2 further illustrates an N7 policy update message 210 (hereinafter policy message 210 or message 210) and an N7 policy update response message 212 (hereinafter policy response message 212 or response message 212). The vendor indicator may be sent in the same way in message 210 as it was in message 206 and processed in the same way by the PCF 204. The policy may be conveyed in the same way in the response message 212 as it was in response message 208.

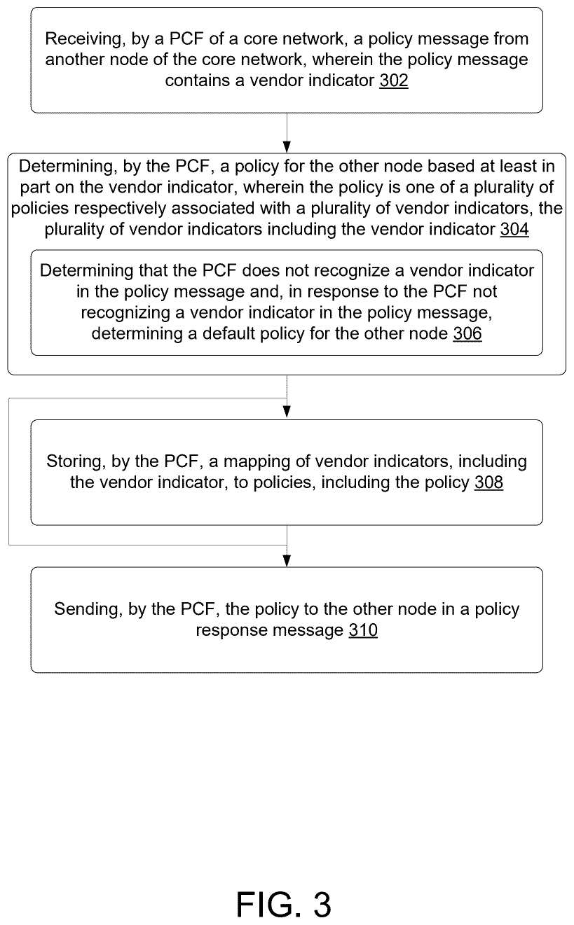

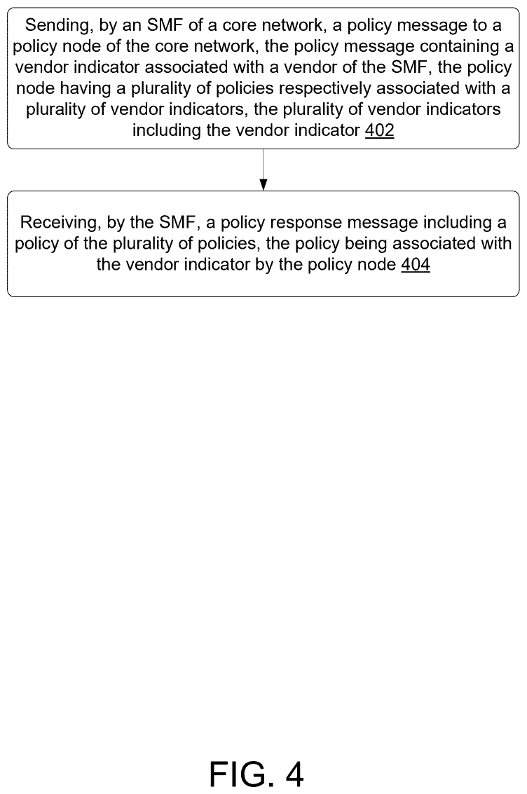

FIGS. 3 and 4 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for receiving, by a PCF, a message from another node that includes a vendor indicator, determining a policy for the other node based at least in part on the vendor indicator, and sending the policy to the other node. As illustrated at 302, a PCF of a core network receives a policy message from another node of the core network, with the policy message containing a vendor indicator.

In some implementations, the other node may be an SMF and the policy message may be an N7 policy create message or an N7 policy update message. The vendor indicator may be associated with a specific vendor and the plurality of vendor indicators may be associated with a respective plurality of vendors. Further, vendors of the plurality of vendors may be associated with different ones of home internet, business internet, or consumer internet.

Further, the vendor indicator may be an additional parameter of a header of the policy message or a repurposed parameter or part of a parameter of the header of the policy message. Also or instead, the vendor indicator may comprise differences in a header of the policy message relative to headers of other policy messages of a same type, wherein the differences are specific to a vendor.

At 304, the PCF determines a policy for the other node based at least in part on the vendor indicator. The policy may be one of a plurality of policies respectively associated with a plurality of vendor indicators, the plurality of vendor indicators including the vendor indicator. At 306, the determining the policy further includes determining that the PCF does not recognize a vendor indicator in the policy message and, in response to the PCF not recognizing a vendor indicator in the policy message, determining a default policy for the other node. In some implementations, the policy may specify, for a user equipment, at least one of an uplink speed, a downlink speed, a QoS, a QCI, a charging rule base, or a charging rule name.

At 308, the PCF may store a mapping of vendor indicators, including the vendor indicator, to policies, including the policy.

At 310, the PCF may send the policy to the other node in a policy response message.

FIG. 4 is a flow diagram of an illustrative process for sending, by an SMF, a message to a policy node, the message including a vendor indicator of a vendor of the SMF and receiving a policy from the policy node in response, the policy determined by the policy node based at least in part on the vendor indicator.

As illustrated at 402, an SMF of a core network sends a policy message to a policy node of the core network, with the policy message containing a vendor indicator. The vendor indicator is associated with a vendor of the SMF. The policy node has a plurality of policies respectively associated with a plurality of vendor indicators, with the plurality of vendor indicators including the vendor indicator.

In some implementations, the policy node may be a PCF and the policy message may be an N7 policy create message or an N7 policy update message. The vendor indicator may be an additional parameter of a header of the policy message or a repurposed parameter or part of a parameter of the header of the policy message. Further, the vendor indicators of the plurality of vendor indicators may be respectively associated with a plurality of vendors, and the vendors of the plurality of vendors may be associated with different ones of home internet, business internet, or consumer internet. Additionally, the policy may specify, for a user equipment, at least one of an uplink speed, a downlink speed, a QoS, a QCI, a charging rule base, or a charging rule name. In further implementations, the vendor indicator may comprise differences in a header of the policy message relative to headers of other policy messages of a same type, with the differences being specific to a vendor.

At 404, the SMF receives a policy response message including a policy of the plurality of policies, with the policy being associated with the vendor indicator by the policy node.

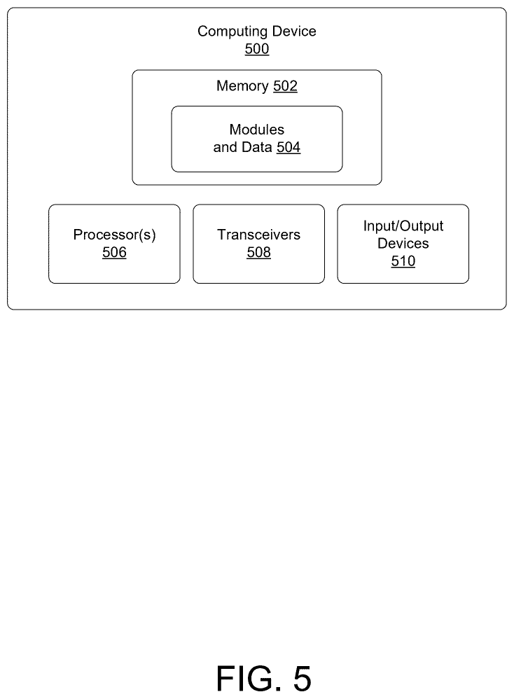

FIG. 5 is a schematic diagram of a computing device capable of implementing functionality of an SMF, the PCF, or multiple ones of these. As shown, the computing device 500 includes a memory 502 storing modules and data 504, processor(s) 506, transceivers 508, and input/output devices 510.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 502 can include one or more software or firmware elements, such as computer-readable instructions that are executable by the one or more processors 506. For example, the memory 502 can store computer-executable instructions associated with modules and data 504. The modules and data 504 can include a platform, operating system, and applications, and data utilized by the platform, operating system, and applications. Further, the modules and data 504 can implement any of the functionality for the PCF 102, SMF 104, SMF 106 or any other node/device described and illustrated herein.

In various examples, the processor(s) 506 can be a central processing unit (CPU), a graphics processing unit (GPU), or both CPU and GPU, or any other type of processing unit. Each of the one or more processor(s) 506 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 506 may also be responsible for executing all computer applications stored in the memory 502, which can be associated with types of volatile (RAM) and/or nonvolatile (ROM) memory.

The transceivers 508 can include modems, interfaces, antennas, Ethernet ports, cable interface components, and/or other components that perform or assist in exchanging wireless communications, wired communications, or both.

While the computing device need not include input/output devices 510, in some implementations it may include one, some, or all of these. For example, the input/output devices 510 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 510 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 510 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A system comprising:
one or more processors;
a policy node of a core network, the policy node configured to be executed by at least one of the one or more processor to:
receive a policy message from another node of the core network, the policy message containing a vendor indicator,
determine a policy for the other node based at least in part on the vendor indicator, wherein the policy is one of a plurality of policies respectively associated with a plurality of vendor indicators, the plurality of vendor indicators including the vendor indicator, and
send the policy to the other node in a policy response message; and
the other node, configured to be executed by at least one of the one or more processor to send the policy message including the vendor indicator to the policy node and receive the policy response message including the policy in response.

2. The system of claim 1, wherein the policy node is a policy control function, the other node is a session management function, and the policy message is an N7 policy create message or an N7 policy update message.

3. The system of claim 1, wherein the vendor indicator is associated with a specific vendor and the plurality of vendor indicators is associated with a respective plurality of vendors.

4. The system of claim 3, wherein vendors of the plurality of vendors are associated with different ones of home internet, business internet, or consumer internet.

5. The system of claim 1, wherein the policy node is further configured to determine that the policy node does not recognize a vendor indicator in the policy message and, in response, to determine a default policy for the other node.

6. A method comprising:
receiving, by a policy control function (PCF) of a core network, a policy message from another node of the core network, wherein the policy message contains a vendor indicator;
determining, by the PCF, a policy for the other node based at least in part on the vendor indicator, wherein the policy is one of a plurality of policies respectively associated with a plurality of vendor indicators, the plurality of vendor indicators including the vendor indicator; and
sending, by the PCF, the policy to the other node in a policy response message.

7. The method of claim 6, wherein the other node is a session management function and the policy message is an N7 policy create message or an N7 policy update message.

8. The method of claim 6, wherein the vendor indicator is associated with a specific vendor and the plurality of vendor indicators is associated with a respective plurality of vendors.

9. The method of claim 8, wherein vendors of the plurality of vendors are associated with different ones of home internet, business internet, or consumer internet.

10. The method of claim 6, wherein the vendor indicator is an additional parameter of a header of the policy message or a repurposed parameter or part of a parameter of the header of the policy message.

11. The method of claim 6, wherein the policy specifies, for a user equipment, at least one of an uplink speed, a downlink speed, a quality of service (QoS), a QoS class indicator (QCI), a charging rule base, or a charging rule name.

12. The method of claim 6, wherein the vendor indicator comprises differences in a header of the policy message relative to headers of other policy messages of a same type, wherein the differences are specific to a vendor.

13. The method of claim 6, further comprising storing, by the PCF, a mapping of vendor indicators, including the vendor indicator, to policies, including the policy.

14. The method of claim 6, wherein determining the policy further comprises determining that the PCF does not recognize a vendor indicator in the policy message and, in response to the PCF not recognizing a vendor indicator in the policy message, determining a default policy for the other node.

15. A method comprising:
sending, by a session management function (SMF) of a core network, a policy message to a policy node of the core network, the policy message containing a vendor indicator associated with a vendor of the SMF, the policy node having a plurality of policies respectively associated with a plurality of vendor indicators, the plurality of vendor indicators including the vendor indicator; and
receiving, by the SMF, a policy response message including a policy of the plurality of policies, the policy being associated with the vendor indicator by the policy node.

16. The method of claim 15, wherein the policy node is a policy control function and the policy message is an N7 policy create message or an N7 policy update message.

17. The method of claim 15, wherein the vendor indicator is an additional parameter of a header of the policy message or a repurposed parameter or part of a parameter of the header of the policy message.

18. The method of claim 15, wherein the vendor indicators of the plurality of vendor indicators are respectively associated with a plurality of vendors, and the vendors of the plurality of vendors are associated with different ones of home internet, business internet, or consumer internet.

19. The method of claim 15, wherein the policy specifies, for a user equipment, at least one of an uplink speed, a downlink speed, a quality of service (QoS), a QoS class indicator (QCI), a charging rule base, or a charging rule name.

20. The method of claim 15, wherein the vendor indicator comprises differences in a header of the policy message relative to headers of other policy messages of a same type, wherein the differences are specific to a vendor.
